(19) United States
(12) Patent Application Publication
(10) Pub. No.: US 2025/0282034 A1
(43) Pub. Date: Sep. 11, 2025

(54) ELECTRIC SCREW TIGHTENING MACHINE AND ANGLE RATCHET WRENCH

(71) Applicant: MAKITA CORPORATION, Anjo-shi (JP)

(72) Inventor: Ding ZHAO, Anjo-shi (JP)

(73) Assignee: MAKITA CORPORATION, Anjo-shi (JP)

(21) Appl. No.: 19/051,313

(22) Filed: Feb. 12, 2025

(30) Foreign Application Priority Data
Mar. 5, 2024 (JP) 2024-033208

(51) Int. Cl. B25B 21/00; B25B 13/46

(52) U.S. Cl. CPC B25B 21/004; B25B 13/463

(57) ABSTRACT

An electric screw tightening machine includes: a motor including a stator and a rotor that is rotatable with respect to the stator and has a rotor axis extending in a front-rear direction; a motor housing that accommodates the motor; a speed reduction mechanism that decelerates rotation of the motor; a socket to which rotation of the motor is always transmitted via the speed reduction mechanism during rotation of the motor and that has a socket axis intersecting the rotor axis; and a one-way clutch mechanism that is disposed at least partially around the socket, and is configured to allow the socket to rotate due to the rotation of the motor only in one direction during the rotation of the motor and transmit rotation input to the motor housing to the socket only in one direction during stop of the motor.

### CROSS-REFERENCE TO RELATED APPLICATION(S)

The present application claims priority to and incorporates by reference the entire contents of Japanese Patent Application No. 2024-033208 filed in Japan on Mar. 5, 2024.

### TECHNICAL FIELD

The techniques disclosed in the present specification relate to an electric screw tightening machine and an angle ratchet wrench.

### BACKGROUND ART

In the technical field related to an electric screw tightening machine, an electric ratchet wrench as disclosed in WO 2019/026699 A is known.

As described in WO 2019/026699 A, the electric ratchet wrench once converts the rotation of the motor into a reciprocating motion and converts the reciprocating motion into a rotational motion of the socket. In the reciprocating motion caused by the rotation of the motor, for example, the socket rotates in the forward rotation direction during the forward motion, and the socket does not rotate in the forward rotation direction during the backward motion. Therefore, the socket contributes to the fastening work during the forward motion, but the socket does not contribute to the fastening work during the backward motion. Therefore, transmission efficiency of the rotational force from the motor to the socket is low (for example, about 50%). When the transmission efficiency of the rotational force is low, the work efficiency of the electric ratchet wrench is low.

### SUMMARY

One non-limiting object of the present teachings is to suppress a decrease in work efficiency.

In one non-limiting aspect of the present teachings, an electric screw tightening machine includes: a motor including a stator and a rotor that is rotatable with respect to the stator and has a rotor axis extending in a front-rear direction; a motor housing that accommodates the motor; a speed reduction mechanism that decelerates rotation of the motor; a socket to which rotation of the motor is always transmitted via the speed reduction mechanism during rotation of the motor and that has a socket axis intersecting the rotor axis; and a one-way clutch mechanism that is disposed at least partially around the socket, and is configured to allow the socket to rotate due to the rotation of the motor only in one direction during the rotation of the motor and transmit rotation input to the motor housing to the socket only in one direction during stop of the motor.

According to the techniques disclosed in the present specification, a decrease in work efficiency is suppressed.

### BRIEF DESCRIPTION OF THE DRAWINGS

FIG. 1 is a side view illustrating an electric screw tightening machine according to an embodiment;

FIG. 2 is a perspective view from the front illustrating part of the electric screw tightening machine according to the embodiment;

FIG. 3 is a longitudinal sectional view illustrating the electric screw tightening machine according to the embodiment;

FIG. 4 is a block diagram illustrating the electric screw tightening machine according to the embodiment;

FIG. 5 is a perspective view from the front illustrating an output unit according to the embodiment;

FIG. 6 is a longitudinal sectional view illustrating the output unit according to the embodiment;

FIG. 7 is a transverse cross-sectional view illustrating the output unit according to the embodiment;

FIG. 8 is an exploded perspective view from above illustrating the output unit according to the embodiment;

FIG. 9 is an exploded perspective view from below illustrating the output unit according to the embodiment;

FIG. 10 is a perspective view in which a main part of the output unit according to the embodiment is extracted;

FIG. 11 is a view of a ratchet head according to the embodiment when viewed from below; and

FIG. 12 is a side view illustrating the electric screw tightening machine according to the embodiment.

### DETAILED DESCRIPTION

In one or more embodiments, an electric screw tightening machine includes: a motor including a stator and a rotor that is rotatable with respect to the stator and has a rotor axis extending in a front-rear direction; a motor housing that accommodates the motor; a speed reduction mechanism that decelerates rotation of the motor; a socket to which rotation of the motor is always transmitted via the speed reduction mechanism during rotation of the motor and that has a socket axis intersecting the rotor axis; and a one-way clutch mechanism that is disposed at least partially around the socket, and is configured to allow the socket to rotate due to the rotation of the motor only in one direction during the rotation of the motor and transmit rotation input to the motor housing to the socket only in one direction during stop of the motor.

In the above configuration, when the screw is fastened, the socket is rotated by the rotational force of the motor. Since the motor rotates at a high speed, the socket also rotates at a high speed. Since the socket rotates at a high speed, the screw is tightened in a short time. During stop of the motor, the electric screw tightening machine can function as a manual ratchet wrench. Therefore, after tightening the screw by the rotational force of the motor, the user of the electric screw tightening machine can use the electric screw tightening machine with the motor stopped as a manual ratchet wrench to additionally tighten the screw. That is, after tightening the screw at a high speed to some extent by the rotational force of the motor, the user can additionally tighten the screw by using the electric screw tightening machine with the motor stopped as a manual ratchet wrench. Therefore, a decrease in work efficiency is suppressed.

In one or more embodiments, during rotation of the motor, the socket rotates at 800 rpm or more.

In the above configuration, since the socket rotates at a high speed, the tightening work is completed in a short time.

In one or more embodiments, the electric screw tightening machine functions as a manual ratchet wrench during the stop of the motor.

In the above configuration, after tightening the screw at a high speed by the rotational force of the motor, the user can additionally tighten the screw with the electric screw tightening machine with the motor stopped.

In one or more embodiments, the speed reduction mechanism includes: a first bevel gear that rotates about the rotor axis; and a second bevel gear that is rotationally fixed to the socket, meshes with the first bevel gear, and rotates about the socket axis.

In the above configuration, since the rotor axis and the socket axis are orthogonal to each other, the electric screw tightening machine can be used as a manual ratchet wrench. The rotational force of the motor is transmitted to the socket via the first bevel gear and the second bevel gear.

In one or more embodiments, the electric screw tightening machine includes an intermediate shaft configured to couple the planetary gear mechanism and the first bevel gear of the speed reduction mechanism. The electric screw tightening machine is configured such that rotation of the speed reduction mechanism is transmitted to the first bevel gear via the intermediate shaft, and the rotation of the speed reduction mechanism is transmitted to the first bevel gear without via the intermediate shaft.

In the above configuration, the dimension of the electric screw tightening machine in the front-rear direction can be arbitrarily adjusted.

In one or more embodiments, the one-way clutch mechanism allows the socket to rotate in the free direction and blocks the socket from rotating in the lock direction. The one-way clutch mechanism is configured to switch between the free direction and the lock direction. The electric screw tightening machine includes an operation member that is operated to switch between a free direction and a lock direction.

In the above configuration, the user can perform, for example, both the screw tightening work and the screw loosening work using the electric screw tightening machine.

In one or more embodiments, an electric screw tightening machine includes: a sensor that detects an operation state of an operation member; and a controller to which a detection signal of the sensor is input. The controller controls the rotation direction of the motor such that the motor rotates the socket in the forward rotation direction when determining that the forward rotation direction of the socket is the free direction of the socket based on the detection signal of the sensor, and the motor rotates the socket in the reverse rotation direction when determining that the reverse rotation direction of the socket is the free direction of the socket.

In the above configuration, the controller can control the rotation direction of the motor so that the rotational force of the motor is not transmitted in the lock direction of the socket but is transmitted in the free direction. In addition, after tightening the screw by the rotational force of the motor, the user can additionally tighten the screw with an electric screw tightening machine that functions as a manual ratchet wrench without operating the operation member.

In one or more embodiments, the one-way clutch mechanism includes: a cam plate that is disposed at least partially around the socket and rotates about a socket axis by an operation of the operation member; a first ratchet pawl that is movably supported by an upper face of the cam plate and meshes with a gear of the socket; a second ratchet pawl that is movably supported by an upper face of the cam plate and meshes with a gear of the socket; a first spring that generates an elastic force so as to press the first ratchet pawl against a cam projection provided on the upper face of the cam plate; and a second spring that generates an elastic force so as to press the second ratchet pawl against the cam projection. When the cam plate rotates in the forward rotation direction, the first ratchet pawl is away from the socket, the reverse rotation direction is the free direction of the socket, and the forward rotation direction is the lock direction of the socket. When the cam plate rotates in the reverse rotation direction, the second ratchet pawl is away from the socket, the forward rotation direction is the free direction of the socket, and the reverse rotation direction is the lock direction of the socket.

In the above configuration, the free direction and the lock direction of the socket are switched only by operating the operation member.

In one or more embodiments, the electric screw tightening machine includes a positioning ball that is to be disposed in a first recess provided in the cam plate when the cam plate is rotated in the forward rotation direction and that is to be disposed in a second recess provided in the cam plate when the cam plate is rotated in the reverse rotation direction.

In the above configuration, the cam plate is positioned by the positioning ball.

Hereinafter, embodiments will be described with reference to the drawings. In the embodiment, the positional relationship of each part will be described using terms of left, right, front, rear, up, and down. These terms indicate the relative position or the direction with respect to the center of an electric screw tightening machine 1. The electric screw tightening machine 1 includes a motor 2 as a power source. In the embodiment, the rotor axis AX indicating the rotation axis of the motor 2 extends in the front-rear direction.

### Electric Screw Tightening Machine

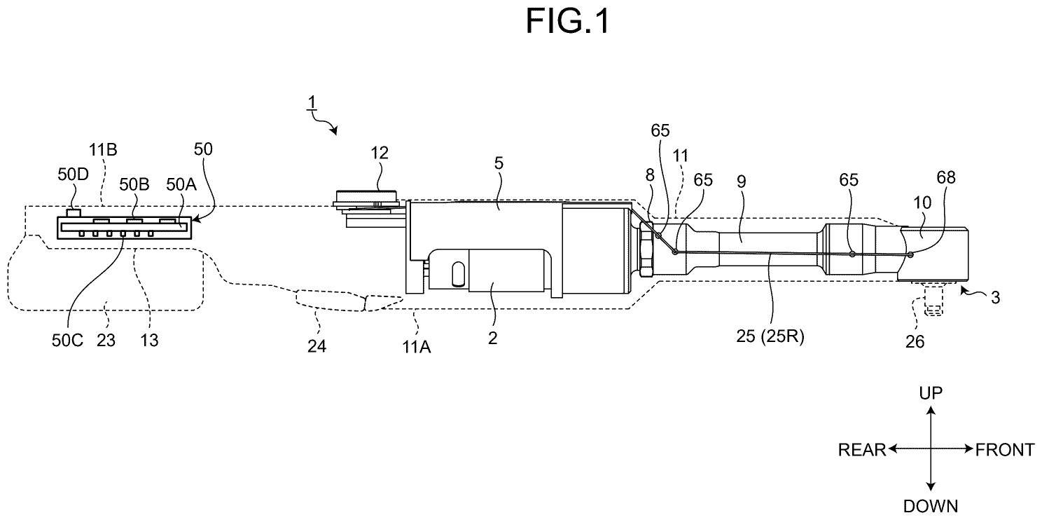

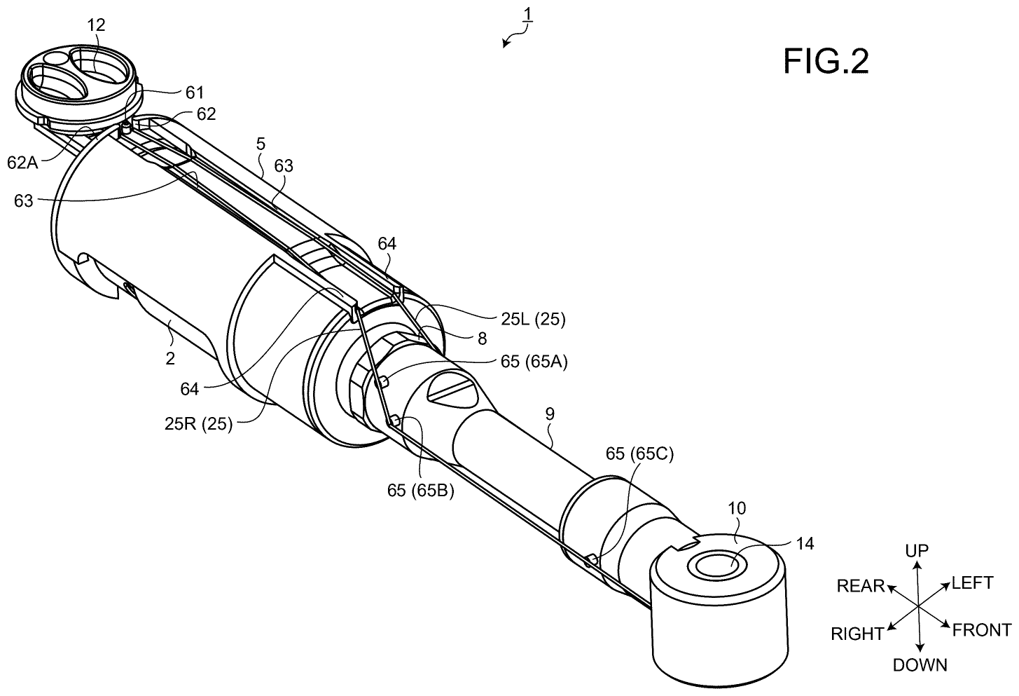

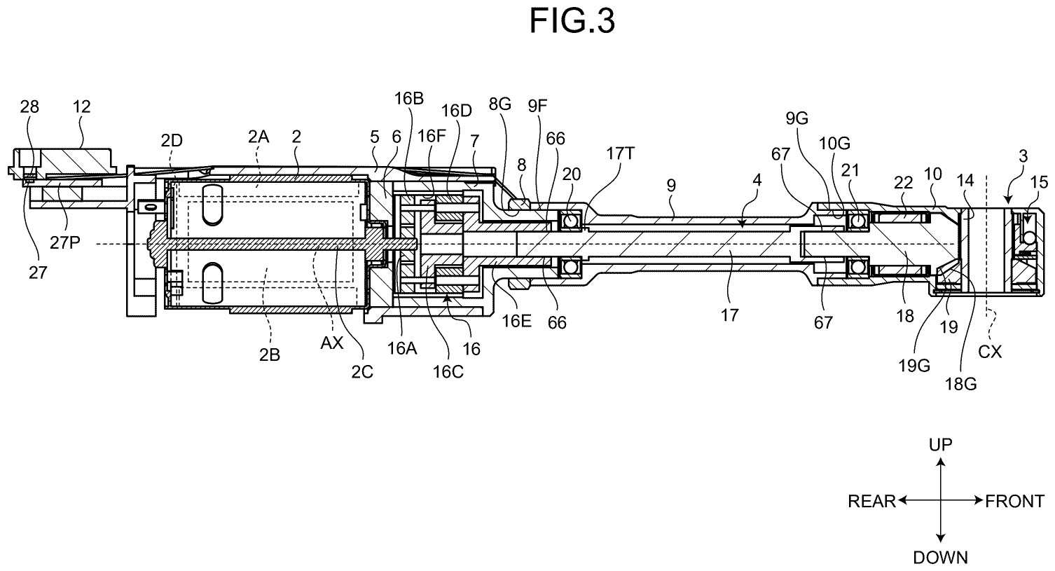

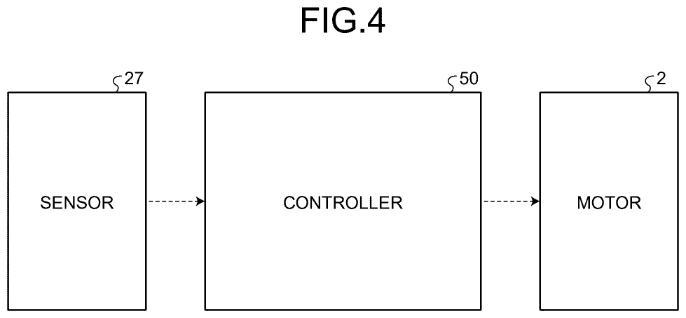

FIG. 1 is a side view illustrating the electric screw tightening machine 1 according to the embodiment. FIG. 2 is a perspective view from the front the illustrating part of the electric screw tightening machine 1 according to the embodiment. FIG. 3 is a longitudinal sectional view illustrating the electric screw tightening machine 1 according to the embodiment. FIG. 4 is a block diagram illustrating the electric screw tightening machine 1 according to the embodiment.

The electric screw tightening machine 1 is an angle ratchet wrench. The electric screw tightening machine 1 includes the motor 2, an output unit 3, a power transmission mechanism 4, a motor case 5, a motor bracket 6, a gear case 7, a lock nut 8, an extension case 9, a ratchet head 10, a motor housing 11, an operation member 12, a battery mounting portion 13, a sensor 27, and a controller 50.

The motor 2 is a power source of the electric screw tightening machine 1. The motor 2 is an inner rotor type DC brushless motor. The motor 2 extends in the front-rear direction. The rotor axis AX extends in the front-rear direction. The motor 2 generates a rotational force about the rotor axis AX. The motor 2 is accommodated in the motor case 5. The motor bracket 6 is disposed between the motor case 5 and the gear case 7. The motor bracket 6 is disposed inside the motor case 5. The motor bracket 6 is disposed so as to cover the opening at the rear end portion of the gear case 7.

The motor 2 includes a stator 2A, a rotor 2B having the rotor axis AX that is rotatable with respect to the stator 2A and extends in the front-rear direction, and a rotor shaft 2C fixed to the rotor 2B. The stator 2A includes a stator core, an insulator fixed to the stator core, and coils respectively wound around teeth of the stator core via the insulator. The rotor 2B is disposed radially inside the stator 2A. The rotor 2B is rotatable at a position radially inside the stator 2A. The rotor 2B includes a rotor core and a magnet fixed to the rotor core. The rotor 2B is disposed around the rotor shaft 2C. The rotor shaft 2C is long in the front-rear direction. The central axis of the rotor shaft 2C coincides with the rotor axis AX.

A sensor substrate 2D on which three Hall ICs (magnetic sensors) are mounted is fixed to a rear portion of the stator 2A. The Hall ICs detect the rotation of the rotor 2B by detecting the magnetic force of the magnet of the rotor 2B. The detection signals of the Hall ICs are transmitted to the controller 50. The controller 50 controls the rotation of the motor 2 based on the detection signals from the Hall ICs.

The output unit 3 includes a socket 14 having a socket axis CX, and a one-way clutch mechanism 15 that allows the socket 14 to rotate in the free direction and blocks the socket from rotating in the lock direction. The socket axis CX intersects with the rotor axis AX. The socket axis CX is orthogonal to the rotor axis AX. The socket axis CX extends in the vertical direction. The socket 14 is rotatable about the socket axis CX. The socket 14 and the one-way clutch mechanism 15 are accommodated in the ratchet head 10.

The power transmission mechanism 4 transmits the rotational force of the motor 2 to the socket 14. The power transmission mechanism 4 includes a speed reduction mechanism 16 and an intermediate shaft 17. The speed reduction mechanism 16 decelerates the rotation of the rotor 2B (the motor 2). The speed reduction mechanism 16 includes a planetary gear mechanism. The planetary gear mechanism of the speed reduction mechanism 16 is accommodated in the gear case 7. The intermediate shaft 17 is accommodated in the extension case 9.

The speed reduction mechanism 16 is disposed forward of the motor 2. The speed reduction mechanism 16 is connected to the motor 2. The speed reduction mechanism 16 includes a planetary gear mechanism. The planetary gear mechanism is rotated by the rotor 2B. In the embodiment, the speed reduction mechanism 16 includes a front-stage planetary gear set and a rear-stage planetary gear set. That is, the speed reduction mechanism 16 has two-stages of planetary gears. The speed reduction mechanism 16 includes a pinion gear 16A fixed to the front end portion of the rotor shaft 2C of the motor 2, a plurality of planetary gears 16B disposed around the pinion gear 16A, a carrier 16C coupled to the planetary gears 16B via pins, a plurality of planetary gears 16D disposed around the front portion of the carrier 16C, and a carrier 16E coupled to the planetary gears 16D via pins. The front portion of the carrier 16C is a sun gear of the rear-stage planetary gear set. An internal gear 16F is disposed around the pinion gear 16A. The internal gear 16F is provided on the inner circumferential face of the gear case 7. The carrier 16E is fixed to the rear end portion of the intermediate shaft 17. The planetary gear mechanism of the speed reduction mechanism 16 is accommodated in the gear case 7.

The intermediate shaft 17 is disposed forward of the speed reduction mechanism 16. The intermediate shaft 17 is long in the front-rear direction. The intermediate shaft 17 rotates about the rotor axis AX.

The speed reduction mechanism 16 includes: a first bevel gear 18 that rotates about the rotor axis AX; and a second bevel gear 19 that is rotationally fixed to the socket 14, meshes with the first bevel gear 18, and rotates about the socket axis CX. The first bevel gear 18 and the second bevel gear 19 are accommodated in the ratchet head 10.

The intermediate shaft 17 can connect the planetary gear mechanism and the first bevel gear 18 of the speed reduction mechanism 16. The rear end portion of the intermediate shaft 17 is fixed to the carrier 16E of the speed reduction mechanism 16. The intermediate shaft 17 is rotationally fixed to the carrier 16E. A pair of flats 66 is provided at the rear end portion of the intermediate shaft 17. The pair of flats 66 provides a so-called width across flats at the rear end portion of the intermediate shaft 17. The carrier 16E has a tubular shape. When the rear end portion of the intermediate shaft 17 having the width across flats is inserted into the carrier 16E, the intermediate shaft 17 is rotationally fixed to the carrier 16E. The intermediate shaft 17 may be spline-coupled to the carrier 16E or press-fitted into the carrier 16E.

The rear portion of the intermediate shaft 17 is rotatably held by a bearing 20. The bearing 20 is a ball bearing. A protrusion 17T that contacts a front face of an inner ring of the bearing 20 is provided at the rear portion of the intermediate shaft 17. The protrusion 17T has an annular shape surrounding the rotor axis AX. The extension case 9 has a stepped portion that is in contact with the front face of the outer ring of the bearing 20. The front end face of the gear case 7 is in contact with the rear face of the outer ring of the bearing 20. The bearing 20 is positioned by the gear case 7, the extension case 9, and the intermediate shaft 17.

The front end portion of the intermediate shaft 17 is fixed to the first bevel gear 18. The front end portion of the intermediate shaft 17 has a tubular shape. The rear end portion of the first bevel gear 18 is inserted into the intermediate shaft 17. The intermediate shaft 17 is rotationally fixed to the first bevel gear 18. A pair of flats 67 is provided at the rear end portion of the first bevel gear 18. The pair of flats 67 provides a so-called width across flats at the rear end portion of the first bevel gear 18. The intermediate shaft 17 is rotationally fixed to the first bevel gear 18 by inserting the rear end portion of the first bevel gear 18 having the width across flats into the front end portion of the intermediate shaft 17. The first bevel gear 18 may be spline-coupled to the intermediate shaft 17 or press-fitted to the intermediate shaft 17.

The intermediate shaft 17 is accommodated in the extension case 9. The lock nut 8 aligns the motor case 5 and the extension case 9 in the rotation direction. A screw thread is formed on the outer circumferential face of a front end portion of the motor case 5. The inner circumferential face of the lock nut 8 has a screw groove 8G, and is fixed to the outer circumferential face of the front end portion of the gear case 7. The extension case 9 has a tubular shape. The inner circumferential face of the rear end portion of the extension case 9 has a screw groove 9F, and is fixed to the outer circumferential face of the front end portion of the gear case 7.

The rear end portion of the ratchet head 10 has a tubular shape. A screw thread 9G is formed on the outer circumferential face of the front end portion of the extension case 9. The inner circumferential face of the rear end portion of the ratchet head 10 has a screw groove 10G, and is fixed to the outer circumferential face of the front end portion of the extension case 9.

The first bevel gear 18 rotates about the rotor axis AX. The rear portion of the first bevel gear 18 is rotatably held by a bearing 21. The bearing 21 is disposed inside the cylindrical rear end portion of the ratchet head 10. An intermediate portion of the first bevel gear 18 is held by a needle bearing 22. The needle bearing 22 is disposed inside a tubular rear end portion of the ratchet head 10.

The second bevel gear 19 meshes with the first bevel gear 18. The first bevel gear 18 has meshing teeth 18G. The second bevel gear 19 has meshing teeth 19G meshing with the meshing teeth 18G of the first bevel gear 18. The second bevel gear 19 is fixed to the lower portion of the socket 14. The second bevel gear 19 rotates about the socket axis CX. The socket 14 rotates about the socket axis CX together with the second bevel gear 19.

The motor housing 11 is disposed so as to cover the motor case 5, the motor bracket 6, the gear case 7, the lock nut 8, the extension case 9, and the ratchet head 10. The motor 2 is accommodated in the motor housing 11 via the motor case 5. The motor housing 11 includes a handle portion 11A gripped by a user of the electric screw tightening machine 1 and a battery holding portion 11B disposed rearward of the handle portion 11A.

The battery mounting portion 13 is disposed on lower portion of the battery holding portion 11B. A battery pack 23 is attached to the battery mounting portion 13. The battery pack 23 includes a rechargeable lithium-ion battery. The electric screw tightening machine 1 is a rechargeable electric screw tightening machine.

A paddle-shaped lever 24 is disposed on lower portion of the handle portion 11A. When the lever 24 is operated by the user of the electric screw tightening machine 1, the motor 2 is driven.

The operation member 12 is disposed on the upper portion of the handle portion 11A. The operation member 12 is operated by the user of the electric screw tightening machine 1. The operation member 12 is a dial rotatably supported by the handle portion 11A. The operation member 12 is operated to operate the one-way clutch mechanism 15. The one-way clutch mechanism 15 can switch between the free direction and the lock direction of the socket 14. The operation member 12 is operated to switch between the free direction and the lock direction.

The operation member 12 and the one-way clutch mechanism 15 are coupled via a pair of wires 25. The wires 25 include a wire 25L disposed left of the ratchet head 10 and a wire 25R disposed right of the ratchet head 10. When the operation member 12 is rotated in one direction, the wire 25L is pulled backward. When the operation member 12 is rotated in the other direction, the wire 25R is pulled backward. When at least one of the wire 25L and the wire 25R is pulled backward, the one-way clutch mechanism 15 is operated.

The electric screw tightening machine 1 includes a wire dividing protrusion 61, a wire introduction slit 62, wire passage grooves 63, wire guide protrusions 64, and a plurality of protrusions 65 (65A, 65B, 65C).

The wire dividing protrusion 61 is disposed on the upper portion of the rear end portion of the motor case 5. The wire 25 is divided into a wire 25L and a wire 25R by the wire dividing protrusion 61 at the rear end portion of the motor case 5.

The wire introduction slit 62 is disposed on upper portion of the rear end portion of the motor case 5. The wire dividing protrusion 61 is disposed in the wire introduction slit 62. An annular rib 62A is provided at the rear end portion of the motor case 5. The wire introduction slit 62 is provided at upper portion of the rib 62A.

The wire passage grooves 63 allow the wire 25 to pass therethrough. The wire passage grooves 63 are provided forward of the wire dividing protrusion 61. The wire passage grooves 63 are provided at the upper face of the motor case 5 so as to extend in the front-rear direction. The pair of wire passage grooves 63 is provided in the left-right direction. The wire 25L passes through the left-side wire passage groove 63. The wire 25R passes through the right-side wire passage groove 63.

The wire guide protrusions 64 guide the wire 25 forward. The wire guide protrusions 64 are disposed at upper portion of the front end portion of the motor case 5. The wire guide protrusions 64 are provided forward of the respective wire passage grooves 63. The pair of wire guide protrusions 64 is provided in the left-right direction. The wire 25L is guided by the left-side wire guide protrusion 64. The wire 25R is guided by the right-side wire guide protrusion 64.

The protrusion 65 is provided on each of the left side face and the right side face of each of the extension case 9 and the ratchet head 10. The protrusions 65 guide the wire 25. The protrusions 65 includes: a protrusion 65A, a protrusion 65B, and a protrusion 65C each protruding leftward from the left side faces of the extension case 9 and the ratchet head 10; and a protrusion 65A, a protrusion 65B, and a protrusion 65C each protruding rightward from the right side faces of the extension case 9 and the ratchet head 10. The protrusion 65A, the protrusion 65B, and the protrusion 65C are disposed in the front-rear direction. The protrusion 65A is disposed at the rear portion of the extension case 9. The protrusion 65B is disposed forward and downward of the protrusion 65A at the rear portion of the extension case 9. The protrusion 65C is disposed at the rear portion of the ratchet head 10.

A wire hole 68 is provided at each of the left side face and the right side face of the ratchet head 10. The wire 25 having passed through the outside of the extension case 9 is inserted into the inside of the ratchet head 10 through the wire hole 68.

The socket 14 extends in the vertical direction. The socket 14 has the socket axis CX that intersects with the rotor axis AX. Rotation of the motor 2 is always transmitted to the socket 14 via the speed reduction mechanism 16 during rotation of the motor 2. The socket 14 is rotated by the planetary gear mechanism of the speed reduction mechanism 16. A socket adapter 26 as a distal end tool is attached to the socket 14. The upper portion of the socket adapter 26 is inserted into the socket 14. A replacement socket (not illustrated) is attached to the lower portion of the socket adapter 26 protruding downward from the socket 14. The fastening work is performed by rotating the socket 14 in a state where the screw, the bolt, or the nut is inserted into the replacement socket.

The sensor 27 detects an operation state of the operation member 12. The sensor 27 detects the rotation direction of the operation member 12. By detecting the operation state of the operation member 12, the sensor 27 detects that the wire 25L or the wire 25R is pulled backward.

As illustrated in FIG. 3, the sensor 27 is mounted on a sensor substrate 27P. The sensor substrate 27P is supported by the rear portion of the motor case 5. The sensor substrate 27P is disposed downward of the operation member 12. A magnet 28 is fixed to the operation member 12. The sensor 27 is disposed downward of the magnet 28. The sensor 27 can face the magnet 28. When the operation member 12 is operated, the position of the magnet 28 changes. The sensor 27 is a Hall IC (magnetic sensor). The sensor 27 can detect the operation state of the operation member 12 by detecting a change in the magnetic force of the magnet 28. A detection signal of the sensor 27 is transmitted to the controller 50. The controller 50 controls the rotation direction of the motor 2 based on the detection signal from the sensor 27.

The controller 50 controls at least the motor 2. The detection signal of the sensor 27 is input to the controller 50. The controller 50 controls the rotation direction of the motor 2 based on the detection signal of the sensor 27.

The controller 50 includes a circuit board 50A on which a plurality of electronic components is mounted. The controller 50 is disposed inside the battery holding portion 11B of the motor housing 11. Examples of the electronic components mounted on the circuit board 50A include a microcomputer 50B, a switching element 50C such as an MOSDET, and a capacitor 50D. Six switching elements 50C are provided. Note that the electronic components mounted on the circuit board 50A may include a transistor and a resistor.

### Output Unit

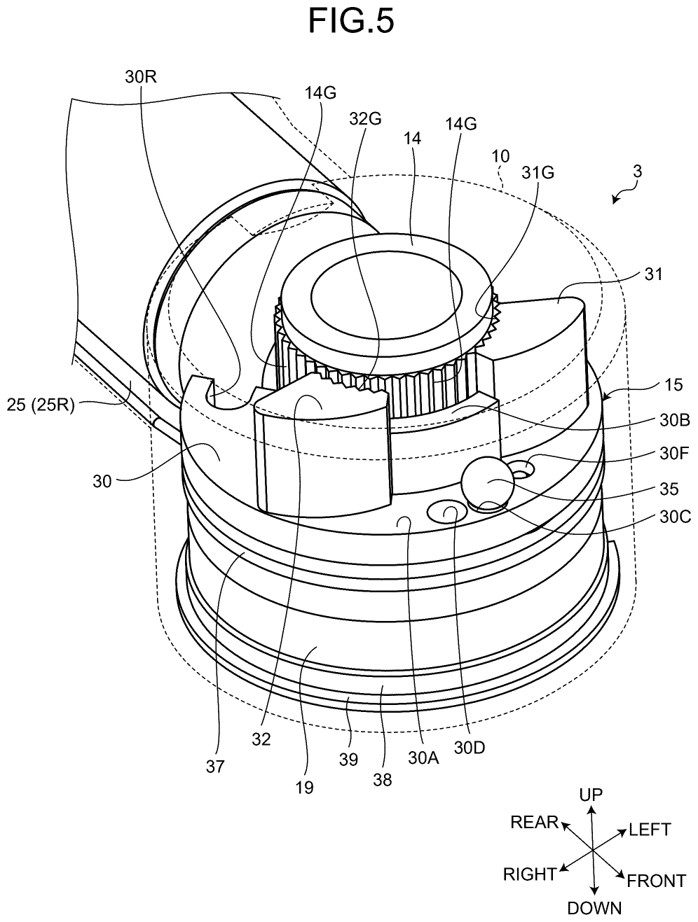

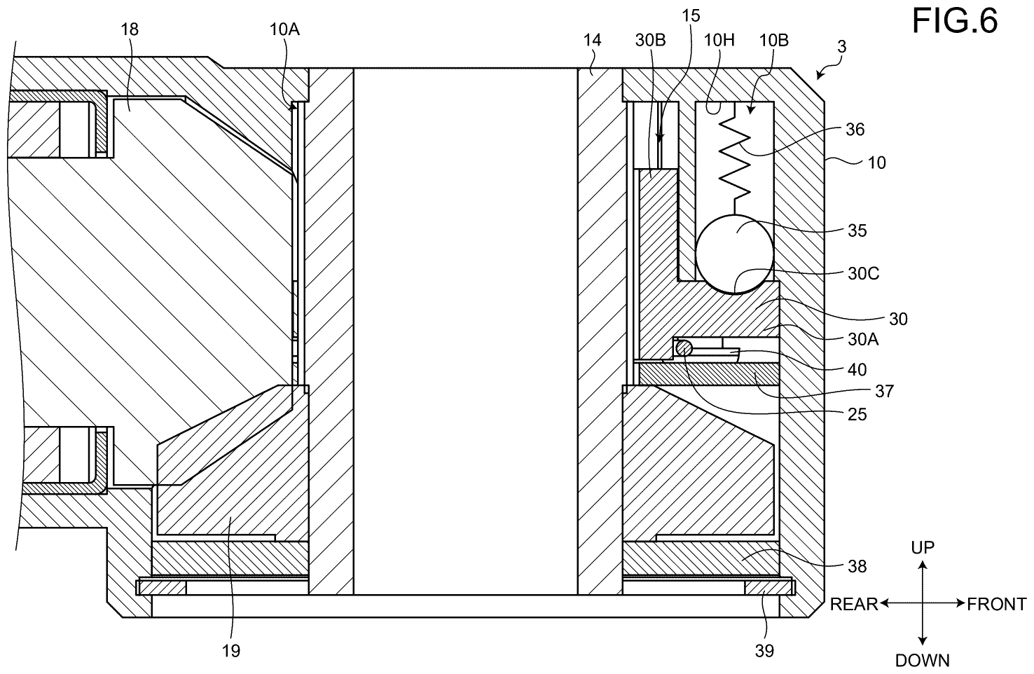

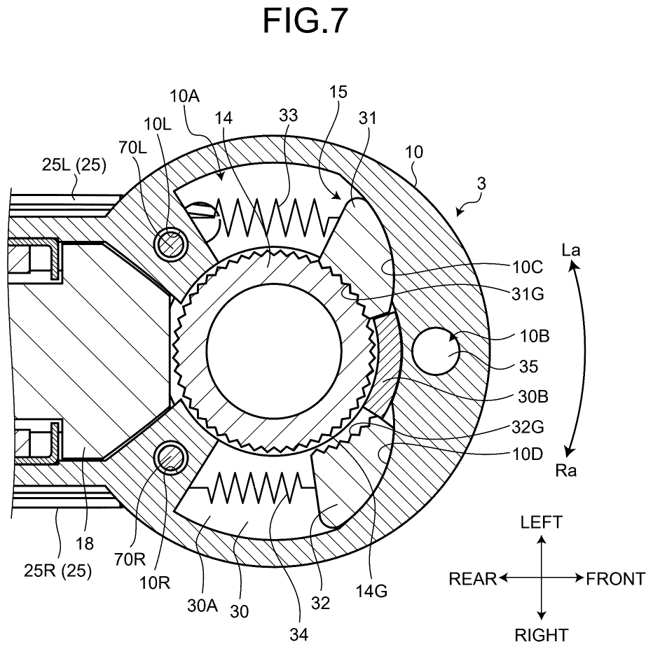

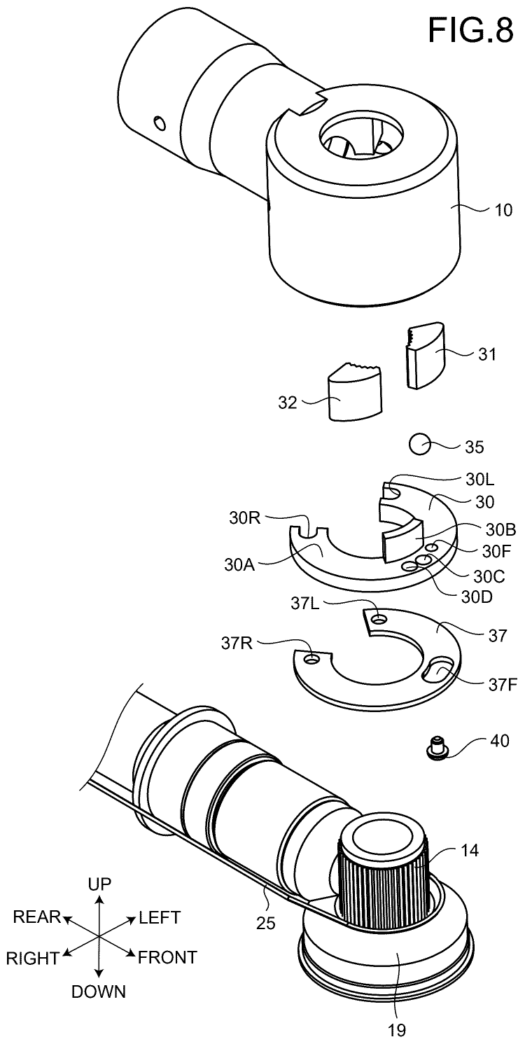

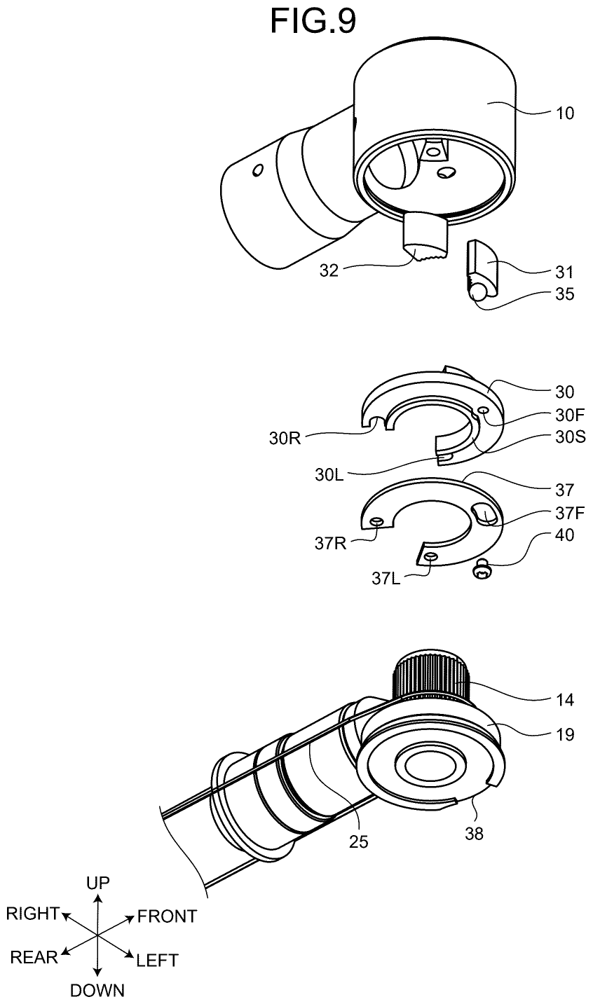

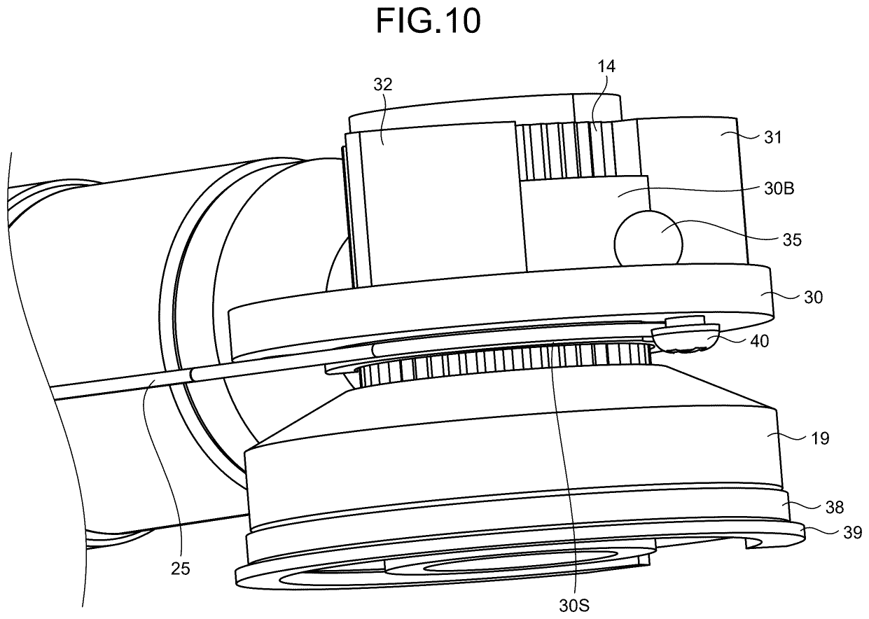

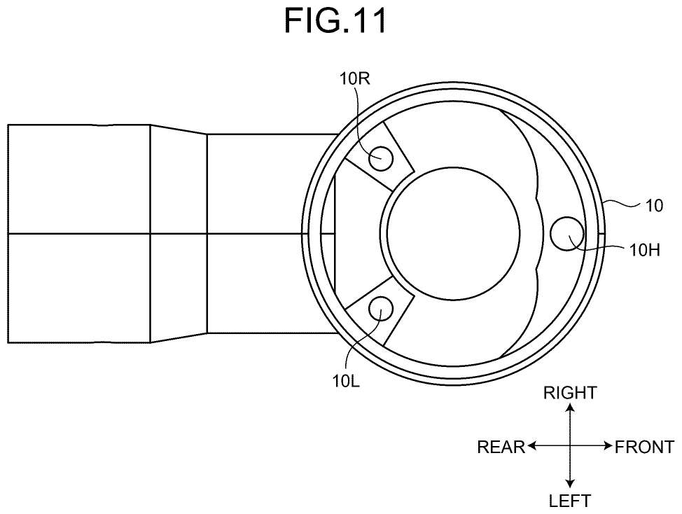

FIG. 5 is a perspective view from the front illustrating the output unit 3 according to the embodiment. FIG. 6 is a longitudinal sectional view illustrating the output unit 3 according to the embodiment. FIG. 7 is a transverse cross-sectional view illustrating the output unit 3 according to the embodiment. FIG. 8 is an exploded perspective view from above illustrating the output unit 3 according to the embodiment. FIG. 9 is an exploded perspective view from below illustrating the output unit 3 according to the embodiment. FIG. 10 is a perspective view of an extracted main part of the output unit 3 according to the embodiment. FIG. 11 is a view of the ratchet head 10 according to the embodiment when viewed from below.

The second bevel gear 19 is disposed around the lower portion of the socket 14. The second bevel gear 19 and the socket 14 are fixed. The meshing teeth 18G of the first bevel gear 18 meshes with the meshing teeth 19G of the second bevel gear 19. When the first bevel gear 18 rotates, the second bevel gear 19 rotates. When the second bevel gear 19 rotates, the socket 14 rotates together with the second bevel gear 19. A gear 14G is provided on an outer face of the socket 14.

The one-way clutch mechanism 15 is disposed at least partially around the socket 14. During rotation of the motor 2, the one-way clutch mechanism 15 allows the socket 14 to rotate only in one direction by the rotation of the motor 2. The socket 14 rotates in the free direction by the rotational force of the motor 2. During rotation of the motor 2, the socket 14 rotates at 800 rpm or more. The socket 14 may rotate at 820 rpm or more. The socket 14 may rotate at 840 rpm or more. The socket 14 may rotate at 850 rpm or more. The socket 14 may rotate at 860 rpm or more. The socket 14 may rotate at 880 rpm or more. The socket 14 may rotate at 900 rpm or more. The socket 14 may rotate at 1000 rpm or more. The rotation speed of the socket 14 is the maximum rotation speed of the socket 14 by the motor 2.

The maximum rotation speed of the socket 14 may be 500 rpm or more. While the maximum rotation speed of the socket 14 is set to 500 rpm or more, the maximum tightening torque by the socket 14 may be set to 50 N·m or more. The maximum tightening torque by the socket 14 may be set to 110 N·m or more.

When the motor 2 is stopped, the electric screw tightening machine 1 functions as a manual ratchet wrench. When the electric screw tightening machine 1 is used as a manual ratchet wrench, the user grips the handle portion 11A of the motor housing 11 and operates the motor housing 11 so that the motor housing 11 rotates (turns) around the socket 14. The rotational force input from the user to the motor housing 11 is transmitted to the socket 14. During stop of the motor 2, the one-way clutch mechanism 15 transmits the rotational force input from the user to the motor housing 11 to the socket 14 only in one direction.

The one-way clutch mechanism 15 includes a cam plate 30, a first ratchet pawl 31, a second ratchet pawl 32, a first spring 33, a second spring 34, a positioning ball 35, a spring 36, a washer 37, a washer 38, a retainer ring 39, and a screw 40. At least the first ratchet pawl 31 and the second ratchet pawl 32 of the one-way clutch mechanism 15 are ratchet portions connectable to the socket 14.

The cam plate 30 is disposed at least partially around the socket 14. The cam plate 30 is rotatable about the socket axis CX with respect to the ratchet head 10. The cam plate 30 is disposed upward of the second bevel gear 19. The cam plate 30 includes a base plate 30A disposed partially around the socket 14, a cam projection 30B projecting upward from the upper face of the base plate 30A, a first recess 30D and a second recess 30C provided at the upper face of the base plate 30A, a screw hole 30F, a pin release recess 30L, a pin release recess 30R, and a wire support projection 30S.

The cam plate 30 is rotatable about the socket axis CX by operating the operation member 12. The cam plate 30 is rotatable in each of a forward rotation direction La and a reverse rotation direction Ra illustrated in FIG. 7.

The socket 14, the first ratchet pawl 31, the second ratchet pawl 32, the first spring 33, and the second spring 34 are disposed in a first internal space 10A of the ratchet head 10. Each of the first ratchet pawl 31 and the second ratchet pawl 32 is movable inside the first internal space 10A. The cam projection 30B is disposed between the first ratchet pawl 31 and the second ratchet pawl 32 in the circumferential direction of the socket axis CX. The first ratchet pawl 31 is disposed on the forward rotation direction La side (left side) of the cam projection 30B. The second ratchet pawl 32 is disposed on the reverse rotation direction Ra side (right side) of the cam projection 30B.

The first ratchet pawl 31 and the second ratchet pawl 32 are relatively movable. The first ratchet pawl 31 has a gear 31G that can mesh with the gear 14G of the socket 14. The second ratchet pawl 32 has a gear 32G that can mesh with the gear 14G of the socket 14.

The first ratchet pawl 31 is movably supported by the upper face of the base plate 30A of the cam plate 30. The first ratchet pawl 31 and the cam plate 30 are relatively movable. The first ratchet pawl 31 is movable in the first internal space 10A while being guided by a first guide face 10C which is part of the inner face of the first internal space 10A.

The second ratchet pawl 32 is movably supported by the upper face of the base plate 30A of the cam plate 30. The second ratchet pawl 32 and the cam plate 30 are relatively movable. The second ratchet pawl 32 is movable in the first internal space 10A while being guided by a second guide face 10D which is part of the inner face of the first internal space 10A.

One end of the first spring 33 is attached to the inner face of the first internal space 10A. The other end of the first spring 33 is attached to the first ratchet pawl 31. The first spring 33 generates an elastic force so as to press the first ratchet pawl 31 against the cam projection 30B.

One end of the second spring 34 is attached to the inner face of the first internal space 10A. The other end of the second spring 34 is attached to the second ratchet pawl 32. The second spring 34 generates an elastic force so as to press the second ratchet pawl 32 against the cam projection 30B.

The base plate 30A of the cam plate 30 has an arc shape disposed partially around the socket 14. The cam projection 30B protrudes upward from the upper face of the base plate 30A. The cam projection 30B has an arc shape disposed partially around the socket 14. The first recess 30D and a second recess 30C are provided on the upper face of the base plate 30A. The second recess 30C is provided left of the first recess 30D. The screw hole 30F is provided in the base plate 30A. The screw hole 30F is provided left of the second recess 30C. The pin release recess 30L is provided so as to be recessed in the reverse rotation direction Ra from the left end portion of the base plate 30A. The pin release recess 30R is provided so as to be recessed in the forward rotation direction La from the right end portion of the base plate 30A. The wire support projection 30S protrudes downward from the inner edge of the lower face of the base plate 30A. The wire support projection 30S has an arc shape disposed partially around the socket 14.

The washer 37 is disposed between the cam plate 30 and the second bevel gear 19. The washer 37 prevents contact between the cam plate 30 and the second bevel gear 19. The washer 37 does not rotate with respect to the ratchet head 10. The washer 37 has an arc shape disposed partially around the socket 14. The washer 37 has a screw release hole 37F, a pin hole 37L, and a pin hole 37R. The screw release hole 37F is provided at the center of the washer 37 in the circumferential direction of the socket axis CX. The screw release hole 37F is a long hole that is long in the left-right direction. The pin hole 37L is provided at the left end portion of the washer 37. The pin hole 37R is provided at the right end portion of the washer 37.

The washer 38 is disposed below the second bevel gear 19. The washer 38 supports the second bevel gear 19 from below. The retainer ring 39 supports the washer 38 from below. The retainer ring 39 is inserted into a notch provided in the ratchet head 10.

A part of the wire 25 and the cam plate 30 are fixed by the screw 40. The front end portion of the wire 25 is disposed so as to wind a part of the wire support projection 30S of the cam plate 30. The front end portion of the wire 25 is hooked on the wire support projection 30S of the cam plate 30. The screw portion of the screw 40 is inserted into the screw hole 30F of the cam plate 30. The screw portion of the screw 40 is coupled to the screw hole 30F. By coupling the screw portion of the screw 40 and the screw hole 30F, the screw 40 is fixed to the cam plate 30. As illustrated in FIG. 6, the front end portion of the wire 25 is sandwiched between the head portion of the screw 40 and the base plate 30A. As a result, a part of the wire 25 and the cam plate 30 are fixed by the screw 40.

The head portion of the screw 40 is disposed in the screw release hole 37F of the washer 37. When the cam plate 30 rotates about the socket axis CX, the screw 40 turns around the socket axis CX. Since the head portion of the screw 40 is disposed in the screw release hole 37F which is a long hole, the rotation of the cam plate 30 is not hindered by the washer 37.

As illustrated in FIG. 7, the output unit 3 includes a pin 70L and a pin 70R. The pin 70L is disposed left rear of the socket 14. The pin 70R is disposed right rear of the socket 14. The washer 37 has the pin hole 37L into which the pin 70L is inserted and the pin hole 37R into which the pin 70R is inserted. The cam plate 30 has the pin release recess 30L in which the pin 70L is disposed and the pin release recess 30R in which the pin 70R is disposed. The ceiling face of the first internal space 10A of the ratchet head 10 is provided with a pin recess 10L in which the upper end portion of the pin 70L is disposed and a pin recess 10R in which the upper end portion of the pin 70R is disposed. The washer 37 is positioned on the ratchet head 10 by the pin 70L and the pin 70R. Since the pin 70L is disposed at the pin release recess 30L and the pin 70R is disposed at the pin release recess 30R, the rotation of the cam plate 30 is not hindered by the pin 70L and the pin 70R.

When the operation member 12 is operated by the user and the wire 25 is pulled, the cam plate 30 rotates. When the wire 25L is pulled backward, the cam plate 30 rotates in the forward rotation direction La. When the wire 25R is pulled backward, the cam plate 30 rotates in the reverse rotation direction Ra.

When the wire 25L is pulled backward and the cam plate 30 rotates in the forward rotation direction La, the first ratchet pawl 31 is pushed in the forward rotation direction La by the cam projection 30B. The first ratchet pawl 31 moves in the forward rotation direction La while being guided by the first guide face 10C against the elastic force of the first spring 33. When the first ratchet pawl 31 moves in the forward rotation direction La, the first ratchet pawl 31 moves radially outward of the socket axis CX. That is, when the first ratchet pawl 31 moves in the forward rotation direction La, the first ratchet pawl 31 is away from the socket 14.

When the wire 25R is pulled backward and the cam plate 30 rotates in the reverse rotation direction Ra, the second ratchet pawl 32 is pushed in the reverse rotation direction Ra by the cam projection 30B. The second ratchet pawl 32 moves in the reverse rotation direction Ra while being guided by the second guide face 10D against the elastic force of the second spring 34. As illustrated in FIG. 7, when the second ratchet pawl 32 moves in the reverse rotation direction Ra, the second ratchet pawl 32 moves radially outward of the socket axis CX. That is, when the second ratchet pawl 32 moves in the reverse rotation direction Ra, the second ratchet pawl 32 is away from the socket 14.

The positioning ball 35 is disposed in a second internal space 10B of the ratchet head 10. The positioning ball 35 is disposed in one of the first recess 30D and the second recess 30C. The spring 36 biases the positioning ball 35 downward. The upper end of the spring 36 is attached to the ceiling face of the second internal space 10B. In the embodiment, the ceiling face of the second internal space 10B has a recess 10H in which the upper end of the spring 36 is accommodated. The upper end of the spring 36 is positioned in the ratchet head 10 by being disposed in the recess 10H. The lower end of the spring 36 is attached to the positioning ball 35.

The positioning ball 35 positions the cam plate 30. When the cam plate 30 moves in the forward rotation direction La so that the first ratchet pawl 31 is away from the socket 14, the positioning ball 35 is disposed in the first recess 30D. When the cam plate 30 rotates in the reverse rotation direction Ra so that the second ratchet pawl 32 is away from the socket 14, the positioning ball 35 is disposed in the second recess 30C.

In a state where the cam plate 30 moves in the forward rotation direction La so that the first ratchet pawl 31 is away from the socket 14, the gear 32G of the second ratchet pawl 32 and the gear 14G of the socket 14 mesh with each other. The socket 14 cannot rotate in the forward rotation direction La (counterclockwise) but can rotate in the reverse rotation direction Ra (clockwise). That is, when the cam plate 30 rotates in the forward rotation direction La and the first ratchet pawl 31 is away from the socket 14, the reverse rotation direction Ra (clockwise) is the free direction of the socket 14, and the forward rotation direction La (counterclockwise) is the lock direction of the socket 14.

As illustrated in FIG. 7, in a state where the cam plate 30 moves in the reverse rotation direction Ra so that the second ratchet pawl 32 is away from the socket 14, the gear 31G of the first ratchet pawl 31 and the gear 14G of the socket 14 mesh with each other. The socket 14 cannot rotate in the reverse rotation direction Ra (clockwise) but can rotate in the forward rotation direction La (counterclockwise). That is, when the cam plate 30 rotates in the reverse rotation direction Ra and the second ratchet pawl 32 is away from the socket 14, the forward rotation direction La (counterclockwise) is the free direction of the socket 14, and the reverse rotation direction Ra (clockwise) is the lock direction of the socket 14.

When the socket 14 is rotated in the forward rotation direction La (counterclockwise) by the rotational force of the motor 2, the user operates the operation member 12 so that forward rotation direction La (counterclockwise) is the free direction of the socket 14. That is, the user operates the operation member 12 so that the second ratchet pawl 32 is away from the socket 14. The operation state of the operation member 12 is detected by the sensor 27. When determining that the forward rotation direction La (counterclockwise) of the socket 14 is the free direction of the socket 14 based on the detection data of the sensor 27, the controller 50 controls the rotation direction of the motor 2 so that the motor 2 rotates the socket 14 in the forward rotation direction La (counterclockwise).

When the socket 14 is rotated in the reverse rotation direction Ra (clockwise) by the rotational force of the motor 2, the user operates the operation member 12 so that reverse rotation direction Ra (clockwise) is the free direction of the socket 14. That is, the user operates the operation member 12 so that the first ratchet pawl 31 is away from the socket 14. The operation state of the operation member 12 is detected by the sensor 27. When determining that the reverse rotation direction Ra (clockwise) of the socket 14 is the free direction of the socket 14 based on the detection signal of the sensor 27, the controller 50 controls the rotation direction of the motor 2 so that the motor 2 rotates the socket 14 in the reverse rotation direction Ra (clockwise).

For example, when the screw tightening work is performed, the operation member 12 is operated so that the socket 14 rotates in the reverse rotation direction Ra (clockwise), that is, the reverse rotation direction Ra (clockwise) is the free direction. The motor 2 generates a rotational force about the rotor axis AX so that the socket 14 rotates in the reverse rotation direction Ra (clockwise).

After tightening the screw owing to the rotational force of the motor 2, the user may additionally tighten the screw. In the embodiment, the electric screw tightening machine 1 functions as a manual ratchet wrench during the stop of the motor 2. After tightening the screw by the rotational force of the motor 2, the user operates the electric screw tightening machine 1 that functions as a manual ratchet wrench to additionally tighten the screw while the motor 2 is stopped.

When the screw is fastened by the rotational force of the motor 2, the operation member 12 is operated so that the reverse rotation direction Ra (clockwise) of the socket 14 is the free direction of the socket 14. When the electric screw tightening machine 1 is used as a manual ratchet wrench to additionally tighten the screw, the user grips the handle portion 11A of the motor housing 11 and operates the motor housing 11 so that the motor housing 11 rotates (turns) around the socket 14. Since the forward rotation direction La (counterclockwise) of the socket 14 is the lock direction of the socket 14, the user can additionally tighten the screw by rotating (turning) the motor housing 11 around the socket 14 in the reverse rotation direction Ra (clockwise). The user can rotate (turn) the motor housing 11 around the socket 14 in the forward rotation direction La (counterclockwise) while maintaining the position of the socket 14 in the rotation direction. By repeating the operation of turning the motor housing 11 in the reverse rotation direction Ra and the operation of turning the motor housing 11 in the forward rotation direction La, the user can use the electric screw tightening machine 1 in a state where the motor 2 is stopped as a manual ratchet wrench.

### Attachment and Detachment of Intermediate Shaft

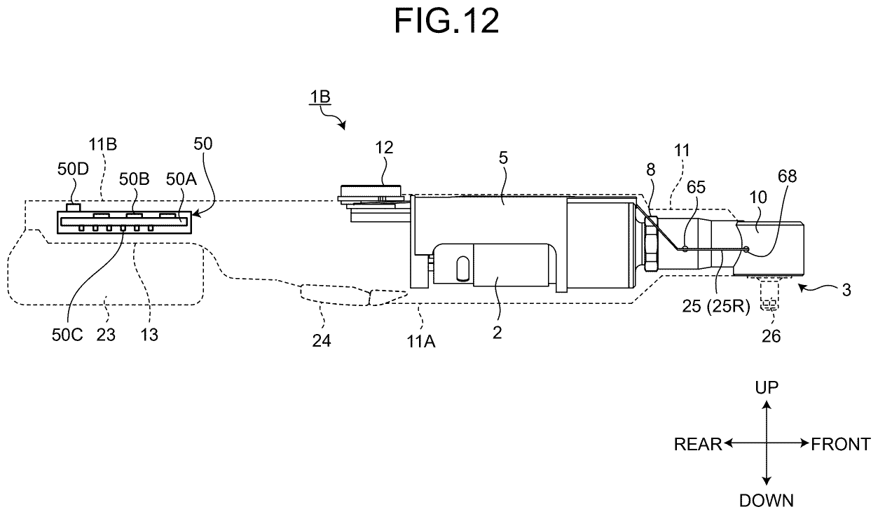

FIG. 12 is a side view illustrating the electric screw tightening machine 1B according to the embodiment. The intermediate shaft 17 is attachable to and detachable from the planetary gear mechanism and the first bevel gear 18 of the speed reduction mechanism 16. When the intermediate shaft 17 is attached to each of the planetary gear mechanism and the first bevel gear 18 of the speed reduction mechanism 16, the rotation of the planetary gear mechanism of the speed reduction mechanism 16 can be transmitted to the first bevel gear 18 via the intermediate shaft 17. When the intermediate shaft 17 is detached from each of the planetary gear mechanism and the first bevel gear 18 of the speed reduction mechanism 16, the rotation of the planetary gear mechanism of the speed reduction mechanism 16 can be transmitted to the first bevel gear 18 without via the intermediate shaft 17.

After the intermediate shaft 17 is removed, the speed reduction mechanism 16 and the first bevel gear 18 are directly coupled. The extension case 9 is attachable to and detachable from the gear case 7 and the ratchet head 10. After the extension case 9 is removed, the gear case 7 and the ratchet head 10 are directly coupled. As illustrated in FIG. 12, the intermediate shaft 17 and the extension case 9 are removed, whereby the dimension of the electric screw tightening machine 1 in the front-rear direction decreases.

### Effects

As described above, in the embodiment, the electric screw tightening machine 1 includes: the motor 2 including the stator 2A and the rotor 2B that is rotatable with respect to the stator 2A and has the rotor axis AX extending in the front-rear direction; the motor housing 11 that accommodates the motor 2; the speed reduction mechanism 16 that decelerates the rotation of the rotor 2B (the motor 2); the socket 14 to which rotation of the motor 2 is always transmitted via the speed reduction mechanism 16 during rotation of the motor 2 and that has the socket axis CX intersecting with the rotor axis AX; and the one-way clutch mechanism 15 that is disposed at least partially around the socket 14, and is configured to allow the socket 14 to rotate due to the rotation of the motor 2 only in one direction during rotation of the motor 2 and transmit the rotation input to the motor housing 11 only in one direction to the socket 14 during stop of the motor 2.

In the above configuration, for example, when the screw is tightened, the socket 14 is rotated by the rotational force of the motor 2. Since the motor 2 rotates at a high speed, the socket 14 also rotates at a high speed. Since the socket 14 rotates at a high speed, the screw is tightened in a short time. During stop of the motor 2, the electric screw tightening machine 1 can function as a manual ratchet wrench. Therefore, after tightening the screw by the rotational force of the motor 2, the user of the electric screw tightening machine 1 can additionally tighten the screw by using the electric screw tightening machine 1 with the motor 2 stopped as a manual ratchet wrench. That is, after tightening the screw at a high speed to some extent by the rotational force of the motor 2, the user can additionally tighten the screw by using the electric screw tightening machine 1 with the motor 2 stopped as a manual ratchet wrench. Therefore, a decrease in work efficiency is suppressed.

In the embodiment, during rotation of the motor 2, the socket 14 rotates at 800 rpm or more.

In the above configuration, since the socket 14 rotates at a high speed, the tightening work is completed in a short time.

In the embodiment, the electric screw tightening machine 1 functions as a manual ratchet wrench during the stop of the motor.

In the above configuration, after tightening the screw at a high speed by the rotational force of the motor 2, the user can additionally tighten the screw by the electric screw tightening machine 1 with the motor 2 stopped.

In the embodiment, the speed reduction mechanism 16 includes: the first bevel gear 18 that rotates about the rotor axis AX; and the second bevel gear 19 that is rotationally fixed to the socket 14, meshes with the first bevel gear 18, and rotates about the socket axis CX.

In the above configuration, since the rotor axis AX and the socket axis CX are orthogonal to each other, the electric screw tightening machine 1 can be used as a manual ratchet wrench. The rotational force of the motor 2 is transmitted to the socket 14 via the first bevel gear 18 and the second bevel gear 19.

In the embodiment, the electric screw tightening machine 1 includes the intermediate shaft 17 configured to couple the planetary gear mechanism and the first bevel gear 18 of the speed reduction mechanism 16. The electric screw tightening machine 1 is configured such that the rotation of the speed reduction mechanism 16 is transmitted to the first bevel gear 18 via the intermediate shaft 17, and the rotation of the speed reduction mechanism 16 is transmitted to the first bevel gear 18 without via the intermediate shaft 17.

In the above configuration, the dimension of the electric screw tightening machine 1 in the front-rear direction can be adjusted in any dimension.

In the embodiment, the one-way clutch mechanism 15 allows the rotation of the socket 14 in the free direction and blocks the socket 14 from rotating in the lock direction. The one-way clutch mechanism is configured to switch between the free direction and the lock direction. The electric screw tightening machine 1 includes the operation member 12 that is operated so as to switch between a free direction and a lock direction.

In the above configuration, the user can perform, for example, both the screw tightening work and the screw loosening work using the electric screw tightening machine 1.

In the embodiment, the electric screw tightening machine 1 includes: the sensor 27 that detects an operation state of the operation member 12; and the controller 50 to which a detection signal of the sensor 27 is input. The controller 50 controls the rotation direction of the motor 2 such that the motor 2 rotates the socket 14 in the forward rotation direction when determining that the forward rotation direction of the socket 14 is the free direction of the socket 14 based on the detection signal of the sensor 27, and the motor 2 rotates the socket 14 in the reverse rotation direction when determining that the reverse rotation direction of the socket 14 is the free direction of the socket 14.

In the above configuration, the controller 50 can control the rotation direction of the motor 2 so that the rotational force of the motor 2 is not transmitted in the lock direction of the socket 14 but is transmitted in the free direction. After tightening the screw by the rotational force of the motor 2, the user can additionally tighten the screw with the electric screw tightening machine 1 functioning as a manual ratchet wrench without operating the operation member 12.

In the embodiment, the one-way clutch mechanism 15 includes: the cam plate 30 that is disposed at least partially around the socket 14 and rotates about the socket axis CX by the operation of the operation member 12; the first ratchet pawl 31 that is movably supported by the upper face of the cam plate 30 and meshes with the gear of the socket 14; the second ratchet pawl 32 that is movably supported by the upper face of the cam plate 30 and meshes with the gear of the socket 14; the first spring 33 that generates an elastic force so as to press the first ratchet pawl 31 against the cam projection 30B provided on the upper face of the cam plate 30; and the second spring 34 that generates an elastic force so as to press the second ratchet pawl 32 against the cam projection 30B. When the cam plate 30 rotates in the forward rotation direction, the first ratchet pawl 31 is away from the socket 14, the reverse rotation direction is the free direction of the socket 14, and the forward rotation direction is the lock direction of the socket 14. When the cam plate 30 rotates in the reverse rotation direction, the second ratchet pawl 32 is away from the socket 14, the forward rotation direction is the free direction of the socket 14, and the reverse rotation direction is the lock direction of the socket 14.

In the above configuration, the free direction and the lock direction of the socket 14 are switched only by operating the operation member 12.

In the embodiment, the electric screw tightening machine 1 includes the positioning ball 35 that is to be disposed in the first recess 30D provided in the cam plate 30 when the cam plate 30 rotates in the forward rotation direction, and is to be disposed in the second recess 30C provided in the cam plate 30 when the cam plate 30 rotates in the reverse rotation direction.

In the above configuration, the cam plate 30 is positioned by the positioning ball 35.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric screw tightening machine comprising:
a motor including a stator and a rotor, the rotor being rotatable with respect to the stator and having a rotor axis extending a front-rear direction;
a motor housing that accommodates the motor;
a speed reduction mechanism that decelerates rotation of the motor;
a socket to which rotation of the motor is always transmitted via the speed reduction mechanism during rotation of the motor, the socket having a socket axis that intersects with the rotor axis; and
a one-way clutch mechanism that is disposed at least partially around the socket and is configured to
allow the socket to rotate due to the rotation of the motor only in one direction during the rotation of the motor, and
transmit rotation input to the motor housing only in one direction to the socket during stop of the motor.

2. The electric screw tightening machine according to claim 1, wherein
the socket rotates at 800 rpm or more during the rotation of the motor.

3. The electric screw tightening machine according to claim 2, wherein
the electric screw tightening machine functions as a manual ratchet wrench during the stop of the motor.

4. The electric screw tightening machine according to claim 1, wherein
the speed reduction mechanism includes
a first bevel gear that rotates about the rotor axis, and
a second bevel gear that is rotationally fixed to the socket, meshes with the first bevel gear, and rotates about the socket axis.

5. The electric screw tightening machine according to claim 4, further comprising
an intermediate shaft configured to connect a planetary gear mechanism and the first bevel gear of the speed reduction mechanism, wherein
the electric screw tightening machine is configured such that
rotation of the planetary gear mechanism of the speed reduction mechanism is transmitted to the first bevel gear via the intermediate shaft, and
rotation of the planetary gear mechanism of the speed reduction mechanism is transmitted to the first bevel gear without via the intermediate shaft.

6. The electric screw tightening machine according to claim 1, wherein
the one-way clutch mechanism allows the socket to rotate in a free direction and blocks the socket from rotating in a lock direction, and
the one-way clutch mechanism is configured to switch between the free direction and the lock direction, and
the electric screw tightening machine comprises an operation member that is operated to switch between the free direction and the lock direction.

7. The electric screw tightening machine according to claim 6, further comprising:
a sensor that detects an operation state of the operation member; and
a controller to which a detection signal of the sensor is input, wherein
the controller controls a rotation direction of the motor such that
the motor rotates the socket in a forward rotation direction when determining that the forward rotation direction of the socket is the free direction of the socket based on the detection signal of the sensor, and
the motor rotates the socket in a reverse rotation direction when determining that the reverse rotation direction of the socket is the free direction of the socket based on the detection signal of the sensor.

8. The electric screw tightening machine according to claim 7, wherein
the one-way clutch mechanism includes
a cam plate that is disposed at least partially around the socket and rotates about the socket axis in response to an operation of the operation member,
a first ratchet pawl that is movably supported by an upper face of the cam plate and meshes with a gear of the socket,
a second ratchet pawl that is movably supported by an upper face of the cam plate and meshes with a gear of the socket,
a first spring that generates an elastic force so as to press the first ratchet pawl against a cam projection provided on the upper face of the cam plate, and
a second spring that generates an elastic force so as to press the second ratchet pawl against the cam projection,
when the cam plate rotates in the forward rotation direction, the first ratchet pawl is away from the socket, the reverse rotation direction is the free direction of the socket, and the forward rotation direction is the lock direction of the socket, and
when the cam plate rotates in the reverse rotation direction, the second ratchet pawl is away from the socket, the forward rotation direction is the free direction of the socket, and the reverse rotation direction is the lock direction of the socket.

9. The electric screw tightening machine according to claim 8, further comprising
a positioning ball that is to be disposed in a first recess provided in the cam plate when the cam plate rotates in the forward rotation direction, and is to be disposed in a second recess provided in the cam plate when the cam plate rotates in the reverse rotation direction.

10. The electric screw tightening machine according to claim 1, wherein
the socket has a maximum rotation speed of 850 rpm or more.

11. The electric screw tightening machine according to claim 1, wherein
the socket has a maximum rotation speed of 500 rpm or more and has a maximum tightening torque of 50 N·m or more.

12. The electric screw tightening machine according to claim 1, wherein
the socket has a maximum tightening torque of 110 N·m or more.

13. An angle ratchet wrench comprising:
a brushless motor including a stator and a rotor rotatable radially inside the stator, the brushless motor extending in a front-rear direction;
a planetary gear rotated by the rotor;
a socket that is rotated by the planetary gear and extends in an up-down direction; and
a ratchet portion connectable to the socket, wherein the socket has a maximum rotation speed of 850 rpm or more.

14. An angle ratchet wrench comprising:
a brushless motor including a stator and a rotor rotatable radially inside the stator, the brushless motor extending in a front-rear direction;
a planetary gear rotated by the rotor;
a socket that is rotated by the planetary gear and extends in an up-down direction; and
a ratchet portion connectable to the socket, wherein
the socket has a maximum rotation speed of 500 rpm or more and has a maximum tightening torque of 50 N·m or more.

15. An angle ratchet wrench comprising:
a brushless motor including a stator and a rotor rotatable radially inside the stator, the brushless motor extending in a front-rear direction;
a planetary gear rotated by the rotor;
a socket that is rotated by the planetary gear and extends in an up-down direction; and
a ratchet portion connectable to the socket, wherein
the socket has a maximum tightening torque of 110 N·m or more.
